(19) United States
(12) Patent Application Publication
(10) Pub. No.: US 2009/0262323 A1
(43) Pub. Date: Oct. 22, 2009

(54) MEASUREMENT APPARATUS, EXPOSURE APPARATUS, AND DEVICE MANUFACTURING METHOD

(75) Inventor: Ryo Sasaki, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/427,645

(22) Filed: Apr. 21, 2009

(30) Foreign Application Priority Data
Apr. 22, 2008 (JP) 2008-111902

(51) Int. Cl. G03B 27/74; G01B 11/02

(52) U.S. Cl. 355/68; 356/508

(57) ABSTRACT

A measurement apparatus which measures a surface position of an object comprises a first measurement device configured to make measurement light from the object and reference light from a reference mirror interfere with each other on a light receiving surface of a photo-electric conversion device to form an interference pattern, and photo-electrically convert the interference pattern by the photo-electric conversion device to output an interference signal, a second measurement device configured to measure the surface position of the object, and an arithmetic processing unit configured to detect the surface position of the object based on a peak, of the interference signal, which is ensured to be a peak of a central fringe according to the measurement result obtained using the second measurement device.

### BACKGROUND OF THE INVENTION

1. Field of the Invention

The present invention relates to a measurement apparatus, an exposure apparatus including the measurement apparatus, and a device manufacturing method using the exposure apparatus.

2. Description of the Related Art

An exposure apparatus which projects and transfers the pattern of an original (reticle) onto a substrate by a projection optical system is employed in manufacturing devices such as a semiconductor device and a liquid crystal display device using photolithography.

Along with an increase in the packing density of semiconductor devices, the exposure apparatus is required to project the pattern of an original onto a substrate with a higher resolving power. A minimum feature size (resolution) that the exposure apparatus can transfer is proportional to the wavelength of light for use in exposure and is inversely proportional to the numerical aperture (NA) of the projection optical system. According to this principle, a shorter wavelength corresponds to a better resolution. In view of this, these days, a KrF excimer laser (wavelength: about 248 nm) and an ArF excimer laser (wavelength: about 193 nm) which have relatively short wavelengths are used as the light sources. In addition, immersion exposure has already been put to practical use.

To meet these demands, the mainstream exposure apparatus is currently shifting from a step & repeat exposure apparatus (also called a “stepper”) which transfers the pattern of an original onto a substrate by full-plate exposure to a scanner. The scanner is a step & scan exposure apparatus which accurately exposes a wide field by scanning an original and a substrate relative to a slit-like exposure region at a high speed.

The scanner measures the surface position of the substrate at a predetermined portion on it by a surface position detector of the grazing-incidence scheme before the predetermined portion reaches the slit-like exposure region. In exposing the predetermined portion, the scanner performs correction so that the substrate surface is aligned with an optimum imaging position of the projection optical system.

To measure both the level (the position in the focus direction) and the tilt of the substrate surface, a plurality of measurement points are set along the longitudinal direction of the slit-like exposure region (i.e., along a direction perpendicular to the scanning direction). A variety of focus and tilt measurement methods have already been proposed (Japanese Patent Laid-Open No. 2006-269669 and U.S. Pat. Nos. 6,249,351 and 5,133,601).

However, in recent years, as the wavelength of the exposure light is shortening, and the NA of the projection optical system is increasing, the depth of focus is decreasing extremely. To keep up with this trend, the accuracy of aligning the surface of a substrate to be exposed with an optimum imaging plane, that is, the focus accuracy is increasingly becoming stricter. In particular, detection errors of the surface position of a substrate attributed to the performance of an optical system which detects the surface position are becoming non-negligible.

For example, as disclosed in Japanese Patent Laid-Open No. 2006-269669, when trigonometry for obliquely irradiating a substrate with light and detecting the light reflected by the substrate is used, the measurement value is known to have an error due to a variation in the reflectance of the undercoating material of the substrate.

Also, as described in U.S. Pat. No. 6,249,351, even in a method of obliquely irradiating a substrate with light and measuring the surface position of the substrate based on an interference signal of the light (see FIG. 7), the surface position of a sample may be erroneously measured. This erroneous measurement will be explained with reference to FIG. 4. FIG. 4 shows a white light interference signal obtained by scanning the sample in a direction perpendicular to its surface by an actuator based on the arrangement shown in FIG. 7. A signal in case 1 shown in FIG. 4 is a white light interference signal obtained by measuring the surface position of the sample while a resist is applied on a silicon wafer. A white light interference signal between measurement light from a sample surface and reference light from a reference surface normally has a maximum intensity at a position at which the optical path length difference between the measurement light and the reference light is zero, as in case 1. From this viewpoint, to measure the surface position of the sample using a white light interference signal, it is only necessary to detect a position at which the white light interference signal has a peak intensity. For this reason, the surface position of the sample can be detected by detecting the envelope peak of the interference signal or by calculating the peak of a fringe at the central position (to be referred to as a central fringe hereinafter), in which the signal intensity is maximal.

Alternatively, as described in U.S. Pat. No. 5,133,601, the feature of an interference signal that interference fringes have a maximum light intensity contrast while the optical path length difference is zero may be exploited. The method which exploits this feature determines the surface position by calculating the light intensities at several points of the interference signal, detecting a fringe in which interference fringes have a maximum light intensity contrast, and calculating the intensity peak of the fringe (to be referred to as a maximum contrast detection method hereinafter).

Unfortunately, if the thickness of the resist film is as small as around 100 nm, or if substances such as copper and aluminum have stacked on the silicon along with the progress of the semiconductor manufacturing process, a white light interference signal as in case 2 shown in FIG. 4 is often obtained. This is because the interference signal has an intensity which depends not only on interference between measurement light from a sample surface and reference light from a reference surface but also on that between light beams which pass through the resist and are reflected by, for example, the silicon and copper below the resist. When this occurs, an interference signal which is supposed to have a maximum intensity at a position, in the Z direction, at which the optical path length difference between the measurement light from the sample surface and the reference light is zero actually has a maximum intensity in an adjacent interference fringe (to be referred to as a sub-fringe hereinafter). When the envelope peak detection method or the maximum contrast detection method disclosed in U.S. Pat. No. 5,133,601 as the conventional techniques are applied to such an interference intensity signal, measurement errors inevitably occur.

### SUMMARY OF THE INVENTION

The present invention provides reducing measurement errors encountered when a distortion is generated in an interference signal.

One of the aspect of the present invention provides a measurement apparatus which measures a surface position of an object, the apparatus comprising a first measurement device configured to make measurement light from the object and reference light from a reference mirror interfere with each other on a light receiving surface of a photo-electric conversion device to form an interference pattern, and photo-electrically convert the interference pattern by the photo-electric conversion device to output an interference signal, a second measurement device configured to measure the surface position of the object, and an arithmetic processing unit configured to detect the surface position of the object based on a peak, of the interference signal, which is ensured to be a peak of a central fringe according to the measurement result obtained using the second measurement device.

Further features of the present invention will become apparent from the following description of exemplary embodiments with reference to the attached drawings.

### BRIEF DESCRIPTION OF THE DRAWINGS

FIG. 1 is a view showing the schematic arrangement of a surface position measurement device (first measurement device) according to a preferred embodiment of the present invention;

FIG. 2 is a flowchart showing a surface position measurement method according to the first embodiment of the present invention;

FIG. 3 is a flowchart showing a surface position measurement method according to the second embodiment of the present invention;

FIG. 4 is a graph illustrating a white light interference signal which changes depending on the spectral characteristics of an object to be measured;

FIG. 5 is a graph illustrating a white light interference signal distorted due to the influence of the spectral characteristics of an object to be measured;

FIG. 6 is a graph illustrating an ideal white light interference signal;

FIG. 7 is a view showing an arrangement example of a surface position measurement apparatus or shape measurement apparatus;

FIG. 8 is a view showing the arrangement of an exposure apparatus according to a preferred embodiment of the present invention;

FIG. 9 is a view showing an arrangement example of a focus control sensor;

FIG. 10 is a graph showing a white light interference signal according to the second embodiment of the present invention;

FIG. 11 is a flowchart showing an exposure sequence according to a preferred embodiment of the present invention;

FIG. 12 is a flowchart showing a calibration method according to a preferred embodiment of the present invention;

FIG. 13 is a flowchart showing an exposure method according to a preferred embodiment of the present invention; and

FIG. 14 is a diagram for explaining a calibration method according to a preferred embodiment of the present invention.

### DESCRIPTION OF THE EMBODIMENTS

Preferred embodiments of the present invention will be described below with reference to the accompanying drawings. Note that the same reference numerals denote the same elements throughout the drawings, and a repetitive description thereof will not be given.

### First Embodiment

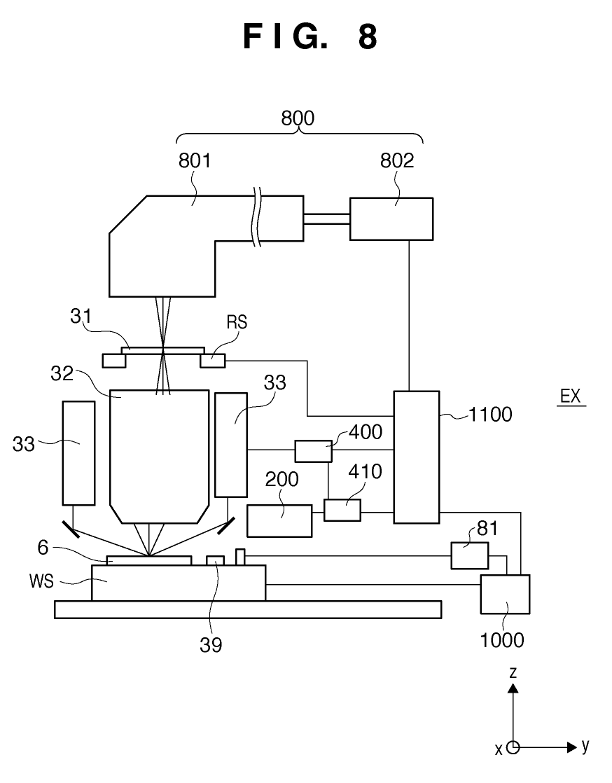

FIG. 8 is a view showing the schematic arrangement of an exposure apparatus according to a preferred embodiment of the present invention. An exposure apparatus EX according to a preferred embodiment of the present invention includes an illumination unit 800, an original stage RS which holds an original (reticle) 31, a projection optical system 32, a substrate stage WS which holds a substrate (e.g., a wafer) 6, and a control unit 1100 as a basic configuration. A reference plate 39 is arranged on the substrate stage WS. The pattern of the original 31 illuminated by the illumination unit 800 is projected onto a substrate 6 by the projection optical system 32 to expose the substrate 6. The substrate 6 is coated with a photoresist, on which a latent image pattern is formed by exposure.

The exposure apparatus EX also includes a surface position measurement interferometer (first measurement device) 200 and focus control sensor (second measurement device) 33 as measurement devices for measuring the surface position of an object (a substrate or a reference plate). The exposure apparatus EX also includes arithmetic processing units 410 and 400. The arithmetic processing unit 410 controls the surface position measurement interferometer 200 and arithmetically processes the signal provided by the surface position measurement interferometer 200 to detect the surface position. The arithmetic processing unit 400 controls the focus control sensor 33 and arithmetically processes the signal provided by the focus control sensor 33 to detect the surface position.

Both the surface position measurement interferometer 200 and the focus control sensor 33 have a function of measuring the surface position or surface shape of the substrate 6 as an object to be measured, but they can have the following differences. The surface position measurement interferometer 200 is a sensor which has a poor response characteristic but is less likely to generate an error due to the pattern formed on the substrate 6. The focus control sensor 33 is a sensor which has a good response characteristic but is more likely to generate an error due to the pattern formed on the substrate 6.

The surface position measurement interferometer 200 makes measurement light from a substrate and reference light from a reference mirror interfere with each other on the light receiving surface of a photo-electric conversion device to form an interference pattern, and photo-electrically converts the interference pattern by the photo-electric conversion device to output an interference signal. On the other hand, the focus control sensor 33 is a measurement device of the grazing-incidence scheme, which obliquely irradiates a substrate with light, and measures the surface position of the substrate based on the image forming position of the light reflected by the substrate. The arithmetic processing unit 410 detects the surface position of the substrate based on a peak, of the interference signal, which is ensured to be that of the central fringe according to the measurement result obtained using the focus control sensor 33.

The control unit 1100 includes a CPU and memory and is electrically connected to the illumination unit 800, original stage RS, substrate stage WS, focus control sensor 33, and surface position measurement interferometer 200 to control the operation of the exposure apparatus. In this embodiment, the control unit 1100 also performs measurement value correction calculation and control when the focus control sensor 33 detects the surface position of the substrate 6.

The illumination unit 800 includes a light source 802 and illumination optical system 801. A laser, for example, is preferable as the light source 802. The laser can be, for example, an ArF excimer laser having a wavelength of about 193 nm or a KrF excimer laser having a wavelength of about 248 nm. The type of light source 802 is not limited to an excimer laser, and an F₂ laser having a wavelength of about 157 nm or an EUV (Extreme UltraViolet) light source having a wavelength of 20 nm or less, for example, may be used.

The illumination optical system 801 illuminates the original 31 inserted in the plane to be illuminated with light emitted by the light source 802. In this embodiment, the illumination optical system 801 illuminates the original 31 with light having a slit-like sectional shape. The illumination optical system 801 can include, for example, a lens, mirror, optical integrator, and stop. The illumination optical system 801 can be used irrespective of whether the illumination light used is on- or off-axis. Although the optical integrator includes an integrator configured as a fly-eye lens or configured by stacking two cylindrical lens arrays (or lenticular lenses), it may be an optical rod or a diffractive element.

The original 31 is made of, for example, quartz, and a pattern to be transferred onto the substrate 6 is formed on the original 31. Light diffracted by the original 31 is projected onto the substrate 6 by the projection optical system 32. The original 31 and the substrate 6 are arranged in an optically conjugate relationship. The pattern of the original 31 can be transferred onto the substrate 6 by scanning them at a speed ratio matching the reduction magnification ratio. Note that the exposure apparatus includes a position detector of the grazing-incidence scheme (not shown), which detects the original 31.

The original stage RS holds the original 31 through a chuck (not shown), and is driven by a driving mechanism (not shown). The driving mechanism includes, for example, a linear motor, and can move the original 31 by driving the original stage RS in the X-, Y-, and Z-axis directions and the rotation directions about the respective axes.

The projection optical system 32 has a function of forming an image of light from the object plane on the image plane. In this embodiment, the projection optical system 32 forms, on the substrate 6, an image of light diffracted by the pattern formed on the original 31. The projection optical system 32 can be an optical system including a plurality of lens elements alone, or an optical system including a plurality of lens elements and at least one concave mirror (catadioptric system). Alternatively, the projection optical system 32 can be, for example, an optical system including a plurality of lens elements and at least one diffractive optical element such as a kinoform. If chromatic aberration correction is necessary, a plurality of lens elements made of glass materials having different degrees of dispersion (Abbe numbers) are used, or the diffractive optical element is configured to cause dispersion in a direction opposite to that caused by the lens elements.

The surface position of the substrate 6 is detected using the focus control sensor 33 and the surface position measurement interferometer 200. Although the substrate 6 can be, for example, a wafer or a glass substrate, it may be another member.

The substrate stage WS holds the substrate 6 by a substrate chuck (not shown). The substrate stage WS drives the substrate 6 in the X-, Y-, and Z-axis directions and the rotation directions about the respective axes using, for example, a linear motor, as in the original stage RS. The original stage RS and the substrate stage WS are driven at a constant speed ratio by monitoring their positions by, for example, a six-axis laser interferometer 81 and an interference signal processing unit 1000. The substrate stage WS is installed on, for example, a stage surface plate supported on the floor or the like through a damper. The original stage RS and the projection optical system 32 are supported by, for example, an optical system support (not shown) mounted on a base frame, which is installed on the floor or the like, through a damper.

Points at which the surface positions (the positions in the direction in which the focus is adjusted) of the substrate 6 are measured will be subsequently explained. In this embodiment, the surface position of the substrate 6 is measured by the focus control sensor 33 while scanning the substrate stage WS in the scanning direction (the Y direction). With this operation, the surface shape of the substrate 6 along the scanning direction is measured. Moreover, the substrate stage WS is driven step by step by ΔX in a direction (the X direction) perpendicular to the scanning direction, and the surface position of the substrate in the scanning direction is measured. By repeating this operation, the entire surface shape of the substrate 6 can be measured. To increase the throughput, the surface positions of the substrate 6 may be simultaneously measured at its different points using a plurality of focus control sensors 33.

An optical level measurement system can be employed as the focus control sensor 33. A method of irradiating the surface of the substrate 6 with light at a small incident angle, and detecting, by a position detection device including, for example, a CCD image sensor, the amount of shift of the light reflected by the surface of the substrate 6 from a reference position can be adopted. It is especially possible to apply light to a plurality of measurement points on the substrate 6, guide the light beams reflected at the respective measurement points to individual sensors, and calculate the tilt of a surface to be exposed from the pieces of level measurement information at different positions.

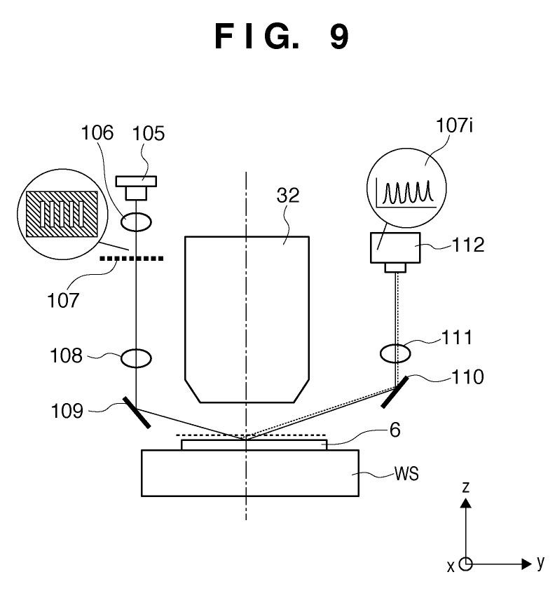

The focus control sensor (second measurement device) 33 will be explained. FIG. 9 is a view showing the schematic arrangement of the focus control sensor 33. Referring to FIG. 9, reference numeral 105 denotes a light source; 106, a condenser lens; 107, a pattern plate in which an array of a plurality of rectangular transmitting slits is formed; 108 and 111, lenses; 109 and 110, mirrors; and 112, a light receiving element such as a CCD.

Light emitted by the light source 105 is converged by the condenser lens 106, and illuminates the pattern plate 107. The light transmitted through the slits in the pattern plate 107 strikes the surface of the substrate 6 at a predetermined incident angle via the lens 108 and the mirror 109. The pattern plate 107 and the substrate 6 hold an imaging relationship with the lens 108, and aerial images of the slits in the pattern plate 107 are formed on the surface of the substrate 6. The light reflected by the substrate 6 is received by the light receiving element 112 via the mirror 110 and the lens 111. The slit images on the substrate 6 are formed again on the light receiving surface of the light receiving element 112 by the lens 111. With this operation, the light receiving element 112 outputs a signal as indicated by 107i, which bears the information of the slit images corresponding to the respective slits in the pattern plate 107. The position of the substrate 6 in the Z direction (its position in the focus direction) can be measured by detecting the amount of shift of that signal from a reference position on the light receiving surface of the light receiving element 112. An amount of optical axis shift m1 on the substrate 6 when the position of the surface of the substrate 6 in the Z direction has changed from w1 to w2 by dZ is given by:

m1=2·dZ·tan θin (1)

where θin is the incident angle.

When the incident angle θin is, for example, 84°, m1=19×dZ, that is, the amount of optical axis shift is 19 times that of displacement of the substrate. The amount of optical axis shift on the light receiving surface of the light receiving element 112 has a value obtained by multiplying equation (1) by the magnification of the optical system (the imaging magnification of the lens 111).

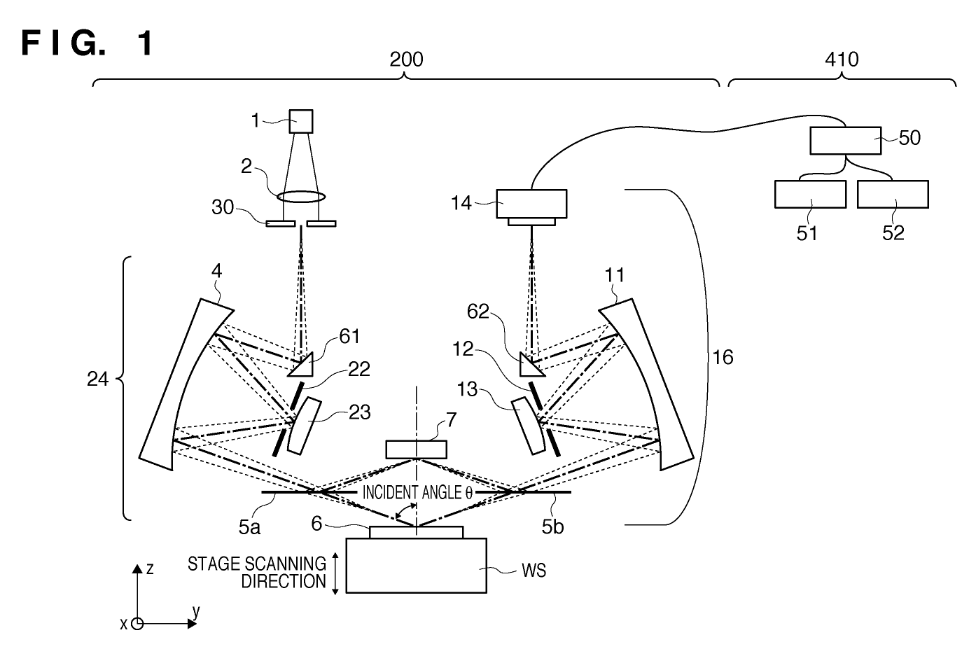

The surface position measurement interferometer (first measurement device) 200 will be explained next with reference to FIG. 1. The surface position measurement interferometer 200 measures the surface position (the position in the Z direction) of the substrate 6 as an object to be measured at each point in the X-Y plane. The surface position measurement interferometer 200 can also measure the average level (surface position) information in a predetermined region in the X-Y plane, and the average tilt information (ωx and ωy). Moreover, if the substrate 6 has a plurality of thin films formed on its surface, the surface position measurement interferometer 200 can measure the level information of the surface of the uppermost thin film, the interface of each thin film, or the underlying substrate itself.

The surface position measurement interferometer 200 includes an illumination unit, light projecting optical system 24, stage system, light receiving optical system 16, and data processing system. The illumination unit includes a light source 1, for emitting light with a wide wavelength range (a wide wavelength interval), such as an LED (e.g., an LED called a white light LED) or a halogen lamp, and a condenser lens 2 for converging the light emitted by the light source 1. The light source 1 may also be configured by combining a plurality of light sources such as lasers having different emission wavelengths in a narrow wavelength range. The illumination unit can also include a slit plate 30 for shaping measurement light applied onto the substrate 6.

The light projecting optical system 24 includes a plane mirror 61, a concave mirror 4, a convex mirror 23, an aperture stop 22, and a beam splitter 5a for splitting light. The plane mirror 61 is unnecessary if there is a space large enough to accommodate the illumination unit without providing the plane mirror 61. In addition, the reflection region on the convex mirror 23 may be limited by, for example, a reflection film instead of providing the aperture stop 22.

The light receiving optical system 16 includes a reference mirror 7, a beam splitter 5b for synthesizing light reflected by the reference mirror 7 and that reflected by the substrate 6, and a photo-electric conversion device 14 such as a CCD sensor or a CMOS sensor. The light receiving optical system 16 also includes a convex mirror 11 and concave mirror 13 for imaging the surface of the substrate 6 on the photo-electric conversion device 14, an aperture stop 12, and a plane mirror 62. The plane mirror 62 is unnecessary if there is a space large enough to accommodate the photo-electric conversion device 14 without providing the plane mirror 62. In addition, the reflection region on the concave mirror 13 may be limited by, for example, a reflection film instead of providing the aperture stop 12. A light amount detection element such as a photodetector may be used in place of the photo-electric conversion device 14.

Although catoptric systems which use mirrors have been exemplified above as the light projecting optical system 24 and the light receiving optical system 16, dioptric systems which use lenses may be adopted.

The stage system includes the substrate stage WS mentioned above, and a driving mechanism for driving it.

The arithmetic processing unit 410 can include a CPU 50, a storage device 51 for storing data, and a display device 52 for displaying the measurement results and conditions.

Light emitted by the light source 1 is guided onto the slit plate 30 via the condenser lens 2. The slit plate 30 has a rectangular transmitting region with a width (a dimension in the Y-axis direction) of 50 μm and a length (a dimension in the X-axis direction) of 700 μm, and forms rectangular images on the substrate 6 and the reference mirror 7 by the light projecting optical system 24. The shape of the transmitting region is not limited to a rectangle, and it may have a circular shape or may be a pinhole. The slit size may be changed in accordance with the required measurement region on the substrate 6. The slit is not limited to a transmitting member, and may be the one obtained by forming a slit-like light transmitting region in a metal plate. The principal ray of the light having passed through the light projecting optical system 24 strikes the substrate 6 at an incident angle θ. Because the beam splitter 5a is inserted in the optical path en route from the light projecting optical system 24 to the substrate 6, nearly a half of the light strikes the reference mirror 7 at the incident angle θ upon being reflected by the beam splitter 5a.

The wavelength range of light emitted by the light source 1 is preferably 400 nm to 800 nm. The wavelength range is not limited to this, and can often be 100 nm or more. Nevertheless, when a resist is formed on the substrate 6, it is desirable to avoid the use of ultraviolet rays (wavelength: 350 nm) or light having a wavelength shorter than that of ultraviolet rays in order to prevent the resist from being exposed to light. The polarization state of the light can be, for example, non-polarization or circular polarization.

As the incident angle θ on the substrate 6 increases, the reflectance of the upper surface of the thin film formed on the substrate 6 becomes relatively larger than that of the lower surface of the thin film. For this reason, the shape of the thin film surface is preferably measured at an incident angle as large as possible. At the same time, as the incident angle becomes closer to 90°, it becomes harder to assemble the optical system, so the incident angle is preferably 70° to 85°.

The concave mirror 4 and the convex mirror 23 may be arranged in a so-called Offner configuration in which the centers of curvature of concave and convex lenses are the center of concentric circles.

Alternatively, the concave mirror 4 and the convex mirror 23 may be arranged in a configuration in which the centers of curvature of concave and convex lenses are the centers of non-concentric circles by setting the curvature of the concave mirror (concave curvature) and that of the convex mirror (convex curvature) to satisfy (convex curvature)=(concave curvature)/2.

The beam splitter 5a can be a cube type beam splitter including a film such as a metal film or a dielectric multilayer film as a split film, or be a pellicle type beam splitter including a film as thin as about 1 μm to 5 μm (its material is, for example, SiC or SiN).

A light component transmitted through the beam splitter 5a strikes the substrate 6, is reflected by the substrate 6 (the light reflected by the substrate 6 can be called measurement light), and enters the beam splitter 5b. On the other hand, a light component reflected by the beam splitter 5a strikes the reference mirror 7, is reflected by the reference mirror 7 (the light reflected by the reference mirror 7 can be called reference light), and enters the beam splitter 5b. The reference mirror 7 can be, for example, an aluminum plane mirror having a surface precision of about 10 nm to 20 nm, or a glass plane mirror having the same surface precision.

The measurement light and the reference light reflected by the substrate 6 and the reference mirror 7, respectively, are synthesized by the beam splitter 5b to form an interference pattern on the light receiving surface of the photo-electric conversion device 14 such as an image sensor. The photo-electric conversion device 14 photo-electrically converts the interference pattern to output an interference signal waveform. The beam splitter 5b can be identical to the beam splitter 5a. The convex mirror 11, the concave mirror 13, and the aperture stop 12 are inserted in the optical path en route from the beam splitter 5b to the photo-electric conversion device 14. The convex mirror 11 and the concave mirror 13 configure a bilateral telecentric light receiving optical system 16 so that the surface of the substrate 6 is imaged on the light receiving surface of the photo-electric conversion device 14. Therefore, in this embodiment, images of the slit plate 30 are formed on the substrate 6 and the reference mirror 7 by the light projecting optical system 24, and an image of the slit plate 30 is formed again on the light receiving surface of the photo-electric conversion device 14.

The convex mirror 11 and concave mirror 13 of the light receiving optical system 16 can be arranged in the same configuration as that between the convex and concave mirrors of the light projecting optical system 24.

The aperture stop 12 set at the pupil position of the light receiving optical system 16 serves to define the numerical aperture (NA) of the light receiving optical system 16. The NA can be, for example, from about sin(0.1°) to about sin(5°). Interference between the measurement light and the reference light takes place on the light receiving surface of the photo-electric conversion device 14 to form an interference pattern.

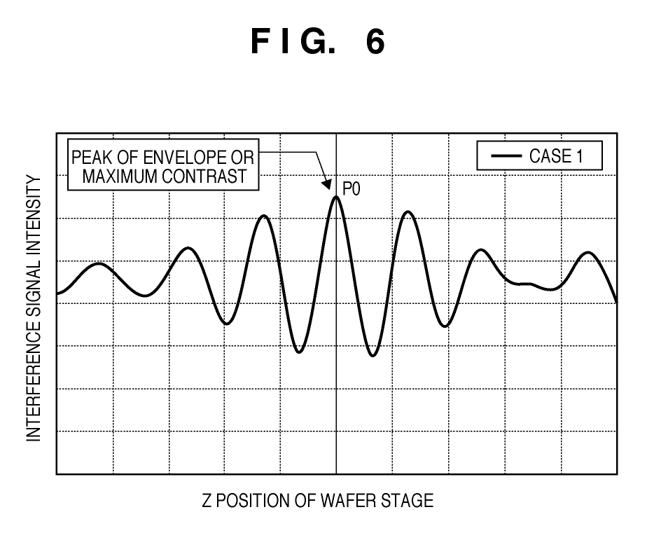

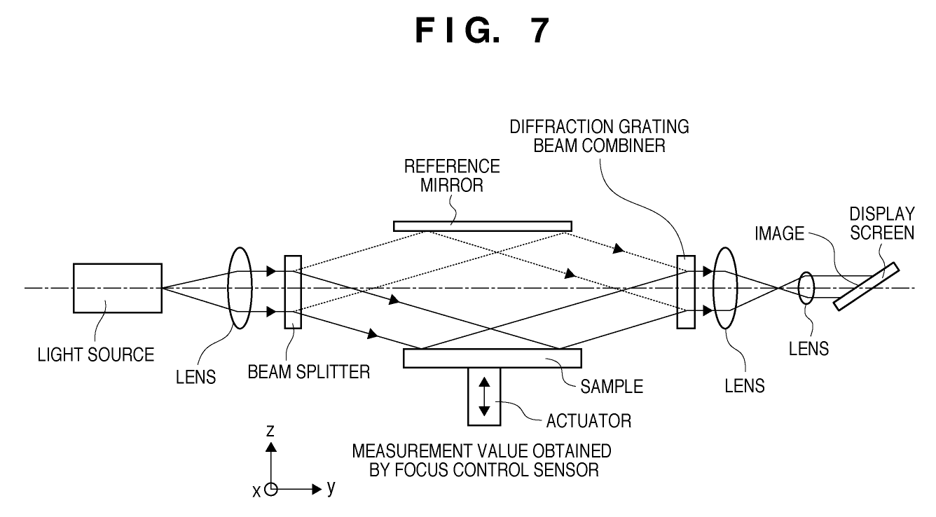

A method of acquiring an interference signal from the interference pattern will be explained subsequently. Referring to FIG. 1, the substrate 6 is held by the substrate chuck and arranged on the substrate stage WS. To obtain a white light interference signal, as illustrated in FIG. 6, by the photo-electric conversion device 14, the substrate stage WS is driven in the Z direction (the direction of the normal to the substrate 6). To change the measurement region on the substrate 6, it is only necessary to drive the substrate stage WS in the X or Y direction to guide the measurement light from the measurement target region to the light receiving region on the photo-electric conversion device 14.

To precisely control the position of the substrate stage WS in the X, Y, and Z directions, a plurality of laser interferometers can be arranged to be able to measure the position of the substrate stage WS along five axes: the X-, Y-, and Z-axes and the tilt axes ωx and ωy. The position and orientation of the substrate stage WS can be controlled by a closed-loop control system based on the outputs from these laser interferometers. This makes it possible to enhance the measurement accuracy of the surface position or surface shape of the substrate 6. The use of laser interferometers is especially advantageous to measuring the shape of the measurement target region on the substrate 6 by dividing it into a plurality of regions, because this allows more precise concatenation (stitching) of shape data.

It is possible to reduce the time taken to measure the entire shape of the substrate 6 using a one-dimensional line sensor (e.g., a photodetector array, a CCD line sensor, or a CMOS line sensor) or a two-dimensional sensor (e.g., a CCD image sensor or a CMOS image sensor) as the photo-electric conversion device 14 in place of a light amount detection element such as a photodetector.

A method of processing the white light interference signal which is detected by the photo-electric conversion device 14 and stored in the storage device 51, thereby obtaining the surface shape of the substrate 6 will be explained subsequently. FIG. 6 shows the white light interference signal (interference signal intensity) from the photo-electric conversion device 14. This white light interference signal is also called an interferogram. In FIG. 6, the abscissa indicates the measurement value obtained by a Z-axis length measurement interferometer (the length measurement sensor may also be a capacitance sensor) upon driving the substrate stage WS in the Z direction, and the ordinate indicates the output (i.e., the interference signal intensity) from the photo-electric conversion device 14. The measurement value obtained by the Z-axis length measurement interferometer in correspondence with the peak position of the white light interference signal calculated in a given detection region serves as the level measurement value in this detection region. The three-dimensional shape of the substrate 6 can be easily measured using an image sensor as the photo-electric conversion device 14.

A method of processing the white light interference signal by the CPU 50 of the arithmetic processing unit 410 will be explained subsequently. As described above, if the waveform of the white light interference signal has deteriorated, the adoption of the conventional envelope peak detection method or maximum contrast detection method may generate a measurement error upon failing to detect the central fringe. However, even if the waveform of the white light interference signal has deteriorated, it is possible to accurately detect the surface position as long as the peak of the central fringe can be detected, according to the white light interference principle in which the optical path length difference between reference light and measurement light is zero at the peak of the central fringe. In other words, in calculating the surface position of the substrate based on the white light interference signal detected by the surface position measurement interferometer 200, it is only necessary to determine the central fringe of the white light interference signal based on the measurement value obtained by the focus control sensor 33 and detect the peak of the central fringe.

The principle of a process by the CPU 50 of the arithmetic processing unit 410 will be explained with reference to FIGS. 5 and 6.

FIG. 6 illustrates a white light interference signal having a non-deteriorated waveform. In this case, a peak P0 of the central fringe matches the maximum peak of the overall white light interference signal, and therefore can be detected even by using the conventional envelope peak detection method or maximum contrast detection method, so erroneous detection never occurs.

FIG. 5 illustrates a white light interference signal having a deteriorated waveform. In this case, the peak of the central fringe does not match the maximum peak of the overall white light interference signal, and therefore the peak of a sub-fringe is detected when the conventional envelope peak detection method or maximum contrast detection method is used. In other words, a peak P1 of a sub-fringe is detected instead of a peak P0 of the central fringe. The fringe interval of the waveform of a white light interference signal when the surface position measurement interferometer 200 is configured assuming that the incident angle on the substrate 6 is around 80° is typically about 1.5 to 2 μm. Hence, the use of the conventional method generates a measurement error of about 1 to 2 μm.

The amount of error generated as the focus control sensor 33 is influenced by the pattern formed on the substrate 6 when it is configured assuming that the incident angle on the substrate 6 is around 80° is known to be about several hundreds of nanometers, that is, 1 μm or less. It is therefore possible to limit the peak detection processing range of a white light interference signal in the surface position measurement interferometer 200 based on the measurement value obtained by the focus control sensor 33. In other words, after the surface position measurement interferometer 200 detects a white light interference signal, the CPU 50 determines a central fringe detection range R using a measurement value F obtained by the focus control sensor 33. The central fringe of the white light interference signal can be determined by selecting an interference fringe peak within the central fringe detection range R. Moreover, the peak of the central fringe, that is, the surface position of the substrate 6 can be detected by signal intensity peak and barycenter calculation or function fitting such as quadratic approximation for the measurement value of the interference intensity of the central fringe.

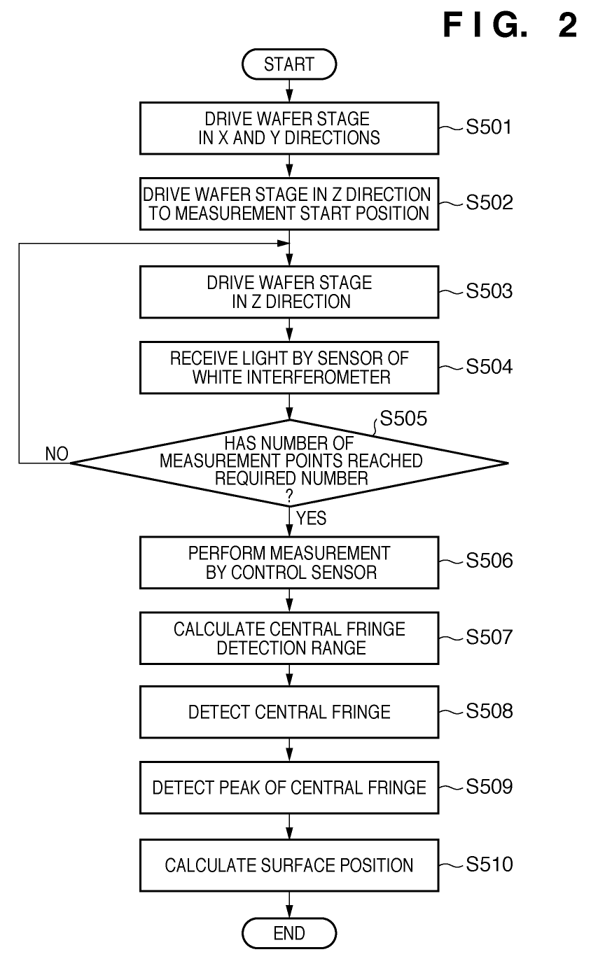

FIG. 2 is a flowchart showing the sequence of a process by the CPU 50 of the arithmetic processing unit 410. First, in step S501, the substrate stage WS is driven in the X and Y directions to be able to measure the measurement target region on the substrate 6.

In step S502, the substrate stage WS is driven in the Z direction to the acquisition start position of a white light interference signal. In step S503, the substrate stage WS is driven in the Z direction by a sampling pitch Zp. In step S504, the interference signal intensity is detected by the photo-electric conversion device 14 of the surface position measurement interferometer 200. In step S505, it is checked whether the detection of interference signal intensities in a number equal to a sampling number required to process the white light interference signal is complete. If the number of detected interference signal intensities has not yet reached the required sampling number, the process returns to step S503. If the number of detected interference signal intensities has reached the sampling number, the process advances to step S506.

In step S506, the surface position of the substrate 6 in its region measured by the surface position measurement interferometer 200 is measured by the focus control sensor 33. By this measurement, a measurement value F of the surface position of the substrate 6 is obtained. In step S507, a central fringe detection range R is determined based on the measurement value F obtained by the focus control sensor 33. The central fringe detection range R can be determined to be, for example, F−r<R<F+r where r is a preset value (>0). The value r can be determined such that two peaks do not simultaneously fall within the central fringe detection range R.

In step S508, the central fringe of the waveform of the white light interference signal is detected based on the central fringe detection range R. In step S509, the peak of the central fringe is detected by, for example, function approximation of the waveform of the central fringe. In step S510, the surface position of the substrate 6 is calculated based on the peak value of the central fringe.

The peak position can be calculated with a resolution of about 1/10 to 1/50 the sampling pitch Zp along the Z-axis, indicated by the abscissa in FIG. 5, by calculating the moving average of the interference signal intensity at the central fringe and detecting the signal intensity peak or performing function fitting for it. The sampling pitch Zp can be given by a method of driving the substrate stage WS in the Z direction step by step at a constant pitch. Alternatively, the sampling pitch Zp may be given by detecting the incident light intensity or the incident light intensity distribution by the photo-electric conversion device 14 while driving a Z stage of the substrate stage WS at a constant speed Zsp.

The surface shape of the substrate 6 can be obtained by measuring the surface positions (levels) of the substrate 6 at a plurality of points in the X and Y directions. The thus obtained surface shape data of the substrate 6 can be stored in the storage device 51 and displayed on the display device 52.

Although a case in which the reference mirror 7 is fixed in position and the substrate 6 is driven has been exemplified in this embodiment, the same effect can be obtained even by fixing the substrate 6 in position and driving the reference mirror 7 in the Z direction.

A white light interference signal can also be obtained without driving the substrate 6 or the reference mirror 7, as disclosed in U.S. Patent Application Publication No. 2007/0086013. In this case, setting a spectroscopic element in front of the photo-electric conversion device, and detecting the interference intensity for each wavelength by the photo-electric conversion device makes it possible to detect the surface position of the substrate 6 based on the interference signal intensity for each wavelength.

In the above-mentioned example, a measurement error of the focus control sensor 33 is small relative to the interval between the central fringe and a sub-fringe of a white light interference signal. Hardware configuration parameters may be determined for the sensors 33 and 200 to satisfy this relationship. The interval between the central fringe and a sub-fringe of a white light interference signal greatly depends on the light incident angle on the substrate surface, and the wavelength range of light emitted by the light source. Furthermore, parameters such as the incident angle, the wavelength of light emitted by the light source, and the NA during measurement mostly account for a measurement error of the focus control sensor 33. Hence, the measurement sequence becomes adoptable by determining parameters for the sensors 33 and 200 so that a measurement error of the focus control sensor 33 is small relative to the interval between the central fringe and a sub-fringe of a white light interference signal.

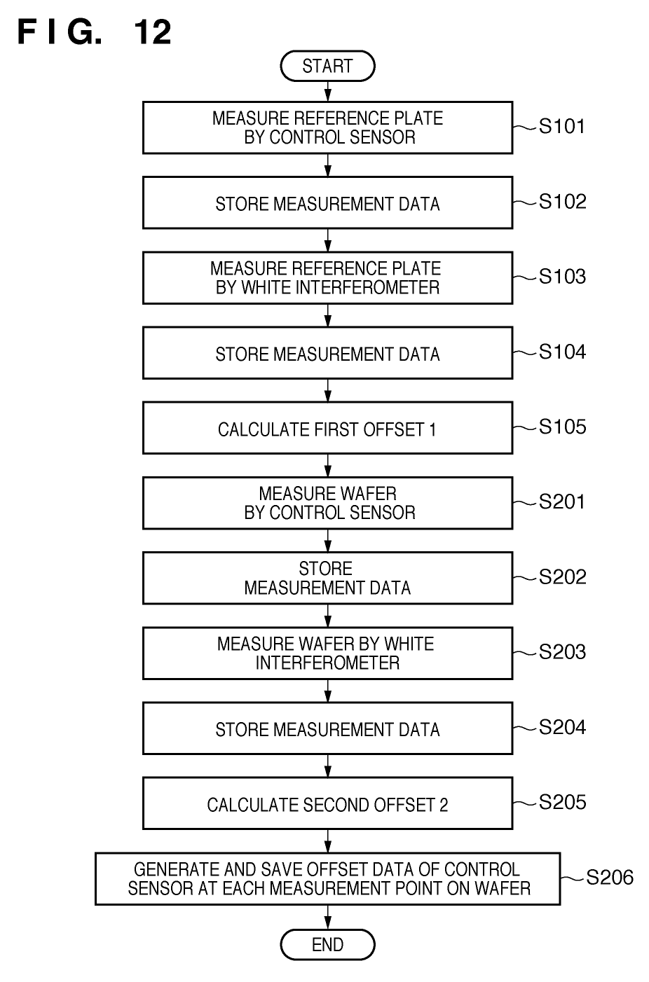

An exposure method for an exposure apparatus according to a preferred embodiment of the present invention will be explained next. FIG. 11 is a flowchart showing the overall sequence of an exposure method for an exposure apparatus according to a preferred embodiment of the present invention. This sequence is controlled by the control unit 1100.

First, in step S1, a substrate (wafer) 6 is loaded into the exposure apparatus. In step S10, it is determined whether to perform focus calibration of the focus control sensor 33 for the substrate 6. This determination can be performed based on pre-registered information concerning substrates, for which focus calibration is desirably performed, such as the first substrate in a lot, substrates in the first lot of a plurality of lots, and substrates to undergo processes which require a strict focus accuracy.

If it is determined in step S10 that focus calibration is unnecessary, the process advances to step S1000 in which a normal exposure sequence is executed. On the other hand, if it is determined in step S10 that focus calibration is necessary, the process advances to a focus calibration sequence in step S100.

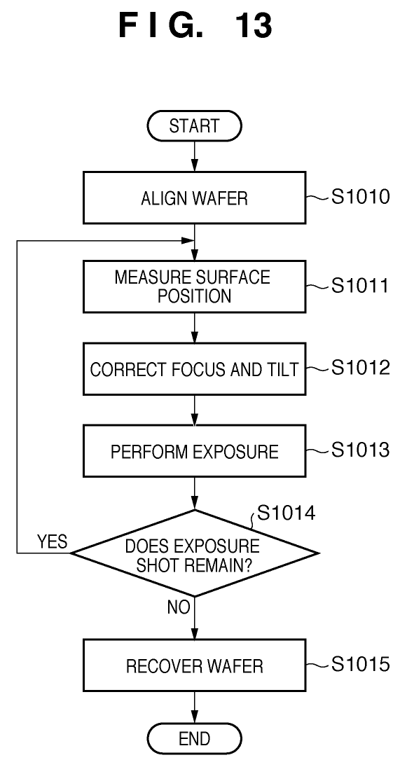

In step S100, a process shown in the flowchart of FIG. 12 is executed. First, the substrate stage WS is driven to position the reference plate 39 in the measurement region of the focus control sensor 33. A glass plate which is called an optical flat and has a high surface precision, or the like can be used as the reference plate 39. A uniform-reflectance region is provided on the surface of the reference plate 39 so as to prevent the generation of a measurement error of the focus control sensor 33, and is measured. A part of a plate on which various types of calibration marks required for other types of calibration (e.g., for alignment detection or evaluation of the projection optical system) of the exposure apparatus are formed may be used as the reference plate 39.

In step S101, the position of the reference plate 39 in the Z direction (its surface position) is detected by the focus control sensor 33. In step S102, a measurement value Om obtained by the focus control sensor 33 is stored. In step S103, the substrate stage WS is driven to position the reference plate 39 in the measurement region of the surface position measurement interferometer 200. After that, the same point as that measured by the focus control sensor 33 is measured by the surface position measurement interferometer 200. In step S104, data on a measurement value Pm obtained by the surface position measurement interferometer 200 is stored.

In step S105, a first offset is calculated. The first offset is the difference between the measurement values Pm and Om obtained by the surface position measurement interferometer 200 and the focus control sensor 33, respectively, as shown in FIG. 14. Note that the first offset must be zero because an optically uniform surface on the reference plate 39 is measured by the surface position measurement interferometer 200 and the focus control sensor 33. However, a first offset may occur due to error factors such as a systematic offset of the substrate stage WS in the scanning direction, and a long-term drift of the focus control sensor 33 or surface position measurement interferometer 200. To avoid this situation, the first offsets are preferably periodically acquired. However, if the above-mentioned error factors do not arise or can be managed in some way, the first offset may be acquired only once. The focus calibration sequence using the reference plate 39 in step S100 is thus completed. Since an optically uniform reference plate 39 is measured in the above-mentioned offset measurement, the conventional envelope peak detection method or maximum contrast detection method may be used in processing the waveform of a white light interference signal in the surface position measurement interferometer 200.

Subsequent to step S100, a focus calibration sequence in step S200 is executed for the substrate 6. In step S201 of FIG. 12, the substrate stage WS is driven to position the substrate 6 so that a preset measurement point on the substrate 6 is positioned in the measurement region of the focus control sensor 33. A measurement point Wp on the substrate 6 must be the same as in an exposure sequence (to be described later).

In step S201, the position of the measurement point Wp in the Z direction on the surface of the substrate 6 is measured by the focus control sensor 33. In step S202, a measurement value Ow obtained by the focus control sensor 33 is stored. In step S203, the substrate stage WS is driven to position the measurement point Wp on the substrate 6 in the measurement region of the surface position measurement interferometer 200, and the position of the measurement point Wp is measured by the surface position measurement interferometer 200. In step S204, data on a measurement value Pw obtained by the surface position measurement interferometer 200 is stored. Note that the measurement point Wp on the surface of the substrate 6 can be determined in accordance with a mode selected from a plurality of modes of designating, for example, one point on a substrate, one point in a shot, all points in a shot, all points in a plurality of shots, and all points on a substrate.

In step S205, a second offset is calculated. The second offset is calculated for each measurement point Wp on the surface of the substrate 6 as the difference between the measurement values Pw and Ow obtained by the surface position measurement interferometer 200 and the focus control sensor 33, respectively, as shown in FIG. 14.

In step S206, the difference between the first and second offsets is calculated for each measurement point on the surface of the substrate 6, and data on the calculated differences are stored. An offset amount Op at each measurement point on the surface of the substrate 6 can be calculated by:

Op(i)=[Ow(i)−Pw(i)]−(Om−Pm) (2)

where i is a number representing the measurement point on the surface of the substrate 6.

An average level offset (Z) and average tilt offsets (ωz and ωy), for example, can be stored as the offset amounts Op for each exposure shot. Because the circuit pattern on the substrate is repeated in shots (dice), the averages of the offset amounts Op in respective shots on the substrate may be calculated and stored.

The focus calibration sequence for the substrate 6 in step S200 is thus completed.

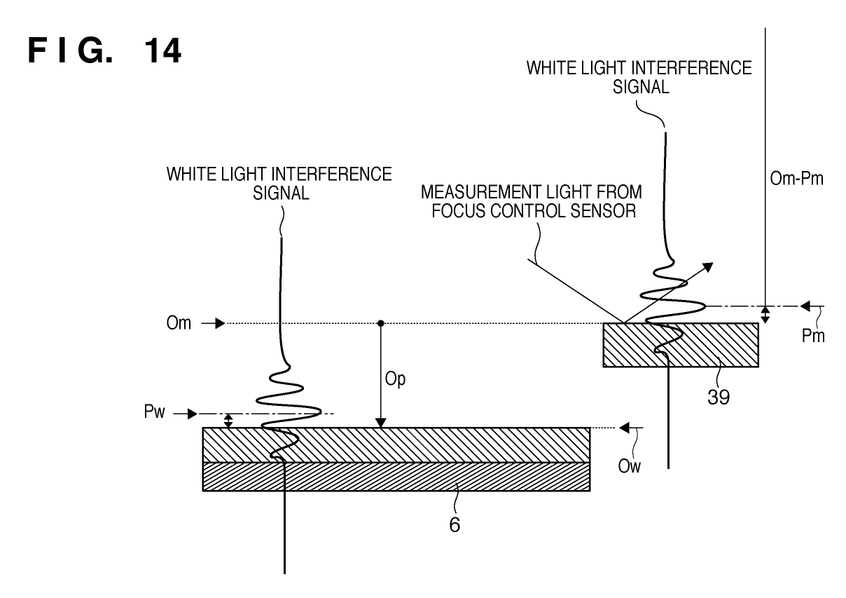

An exposure sequence in step S1000 will be subsequently explained. FIG. 13 shows details of the exposure sequence in step S1000. In step S1010, substrate alignment is performed. In the substrate alignment, the position of a mark on the substrate is detected to align the position of the substrate in the X-Y plane with an optimum position in the exposure apparatus by an alignment scope (not shown). After that, in step S1011, the surface position of the substrate 6 at a predetermined portion on the surface of the substrate 6 is measured by the focus control sensor 33. This predetermined portion is included in the portions measured in the above-mentioned focus calibration sequence. Accordingly, the substrate surface shape data is obtained by correcting the measurement values using the offset amounts Op(i) given by equation (2). The exposure apparatus stores the substrate surface shape data obtained after the correction.

In step S1012, the substrate stage WS is driven to position the substrate so that a first exposure shot is positioned at the exposure position under the projection optical system 32. At the same time, surface shape data in the first exposure shot is generated based on the surface shape data of the substrate 6, and the driving data of the substrate stage in the Z direction and tilt directions is corrected so as to minimize the amount of misalignment of the surface of the substrate 6 with respect to the exposure image plane.

In step S1013, the substrate is scanned and exposed while driving the substrate stage based on the driving data. After the exposure of the first exposure shot is completed in this way, it is checked in step S1014 whether an unexposed shot is present. If an unexposed shot is present, the process returns to step S1012 in which surface shape data in the next shot is generated, and the driving data of the substrate stage in the Z direction and tilt directions is corrected. In step S1014, it is checked whether a shot to be exposed (i.e., an unexposed shot) is present. The above-mentioned operation is repeated until no unexposed shot is present. When the exposure of all exposure shots is complete, the substrate 6 is recovered in step S1015, and the exposure ends.

In this embodiment, immediately before exposure of each exposure shot, surface shape data in the exposure shot is generated, the amount of misalignment of the substrate surface from the exposure image plane is calculated, and the driving amount of the substrate stage is calculated. As another method, before exposure of a first exposure shot, surface shape data in all exposure shots may be generated, the amount of misalignment of the substrate surface from the exposure image plane may be calculated, and the driving amount of the substrate stage may be calculated.

Also, the exposure apparatus is not limited to a single stage configuration including only one substrate stage WS, and may have a twin stage configuration. An exposure apparatus having a twin stage configuration includes an exposure station for exposing a substrate, and a measurement station for measuring the substrate. In an exposure apparatus having a twin stage configuration, the focus control sensor 33 and the surface position measurement interferometer 200 are set in the measurement station.

The substrate has, for example, a complicated circuit pattern and scribe lines formed on it, so a reflectance distribution, a local tilt, and the like are likely to occur. Under the circumstances, the present invention produces a dramatic effect of reducing measurement errors due to a reflectance distribution and a local tilt. In addition, allowing precise measurement of the surface position of the substrate improves the alignment accuracy (focus accuracy) between an optimum exposure plane and the substrate surface, leading to an improvement in the performance of a semiconductor device to be manufactured and an improvement in the manufacturing yield.

### Second Embodiment

An exemplary procedure for calculating the central fringe detection range by the focus control sensor 33 after acquiring a white light interference signal has been explained in the first embodiment. An exemplary procedure for determining the central fringe detection range using a focus control sensor 33 in advance, and acquiring a white light interference signal in this range will be explained in the second embodiment.

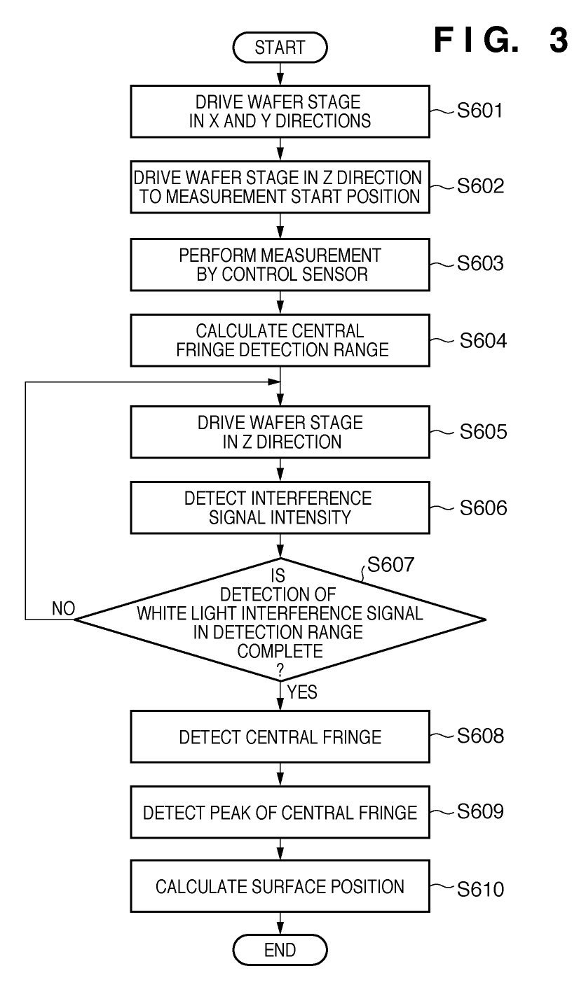

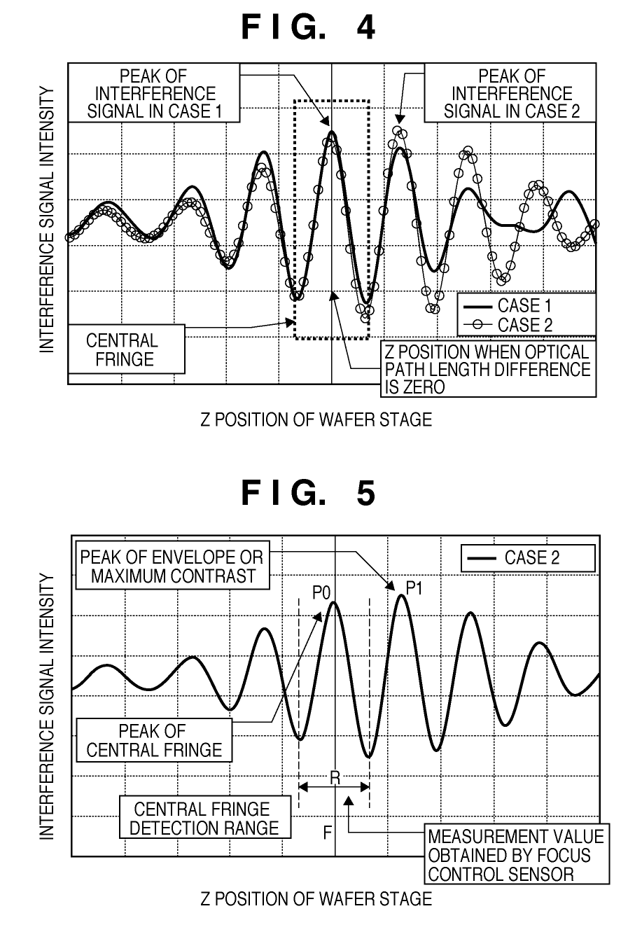

FIG. 3 is a flowchart showing a sequence according to the second embodiment of the present invention. This sequence can be controlled by a CPU 50 of an arithmetic processing unit 410.

First, in step S601, a substrate stage WS is driven in the X and Y directions to be able to measure the measurement target region on a substrate 6. In step S602, the substrate stage WS is driven in the Z direction to be able to measure the surface position of the substrate 6 by the focus control sensor 33.

In step S603, the surface position of the substrate 6 in its measurement target region is measured by the focus control sensor 33. By this measurement, a measurement value F of the surface position of the substrate 6 is obtained. In step S604, a central fringe detection range R is calculated using the measurement value F obtained by the focus control sensor 33. The central fringe detection range R is determined based on the measurement value F obtained by the focus control sensor 33. The central fringe detection range R can be determined to be, for example, F−r<R<F+r where r is a preset value (>0). The value r can be determined such that two peaks do not simultaneously fall within the central fringe detection range R.

The process advances to a sequence of detecting the waveform of a white light interference signal in the calculated central fringe detection range R. The loop from step S605 to step S607 is repeated until the detection of the interference signal intensities at respective points in the central fringe detection range R is completed. In step S605 executed for the first time, the substrate stage WS is driven in the Z direction in accordance with the minimum value of the central fringe detection range R. In step S605 executed for the subsequent times, the substrate stage WS is driven in the Z direction by a sampling pitch Zp. In step S606, the interference signal intensity is detected by a photo-electric conversion device 14 of a surface position measurement interferometer 200. In step S607, it is checked whether the detection of a white light interference signal in the central fringe detection range R is complete. If NO in step S607, the process returns to step S605. If YES in step S607, the process advances to step S608.

In step S608, the central fringe is detected from the waveform of the white light interference signal (interference signal intensity) in the central fringe detection range R. In step S609, the peak of the central fringe is detected. In step S610, the surface position of the substrate 6 is calculated based on the peak value of the central fringe.

To measure the surface positions of the substrate 6 in a plurality of measurement regions on it, a process shown in FIG. 12 can be executed for each measurement region. In other words, for each measurement region, a central fringe detection range R is set using the focus control sensor 33, and a white light interference signal is detected in this range.

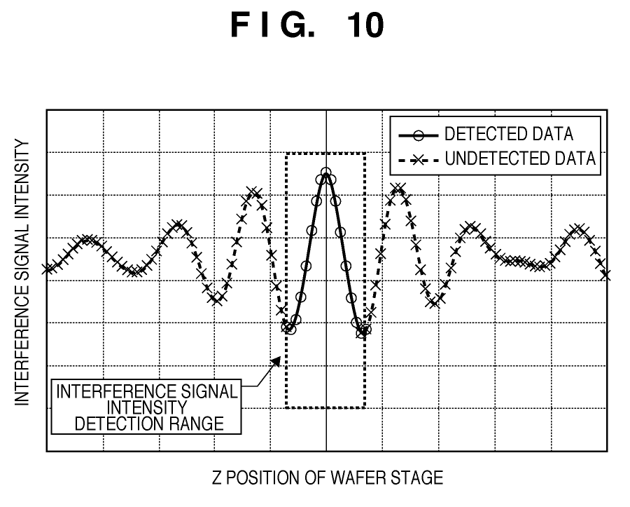

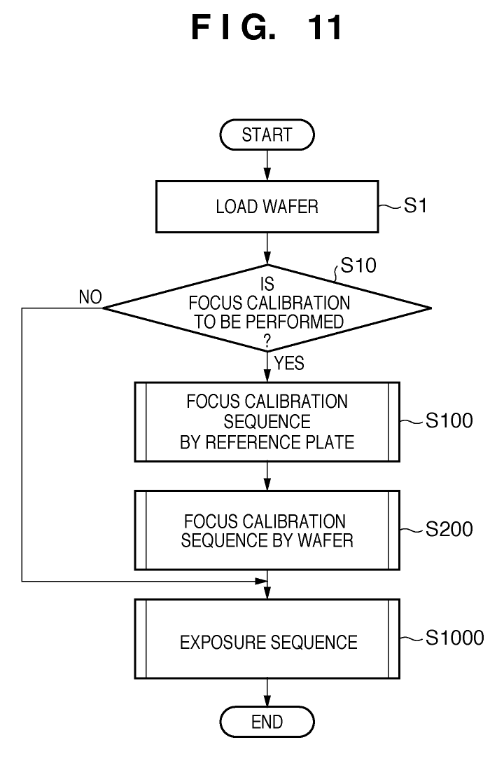

According to the second embodiment, as illustrated in FIG. 10, it is possible to detect the interference signal intensity of the central fringe alone, thus obviating the need to detect data on a sub-fringe unnecessary for the peak detection process. This reduces not only the number of times of measurement but also the number of times of calculation processing and the memory area.

### Other Embodiments

In the second embodiment, a central fringe detection range R is set for each measurement region using the focus control sensor 33, and a white light interference signal is detected in this range. In contrast, it is also possible to measure the surface positions of a substrate 6 in a plurality of measurement regions on it in advance by the focus control sensor 33, set a central fringe detection range R for each of the plurality of measurement regions, and detect a white light interference signal for each measurement region. This makes it possible to measure the surface position of the substrate by the focus control sensor 33 while scanning the substrate, thus shortening the measurement time.

Along with the introduction of, for example, CMP (Chemical Mechanical Polishing), the surface shape of a semiconductor wafer is said to have become flat to the degree that the surface roughness is about several micrometers. When such a flat wafer is used, there is no need to set a central fringe detection range R using the focus control sensor 33 over the entire wafer surface. In this case, a central fringe detection range R on the wafer surface can be set by measuring only several points on the wafer surface.

The focus control sensor 33 is not limited to optical sensor as mentioned above, and may be, for example, an air gauge, a capacitance gauge, or a proximity probe. Alternatively, in addition to the focus control sensor 33, an air gauge, capacitance gauge, or proximity probe may be separately provided to determine a central fringe detection range R. In other words, the focus control sensor 33 mentioned above is used as a sensor for specifying the central fringe.

### Device Manufacturing Method

A device manufacturing method according to a preferred embodiment of the present invention is suitable for manufacturing, for example, a semiconductor device and a liquid crystal device. This method can include a step of transferring the pattern of an original onto a photoresist applied on a substrate using the above-described exposure apparatus, and a step of developing the photoresist.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-111902, filed Apr. 22, 2008, which is hereby incorporated by reference herein in its entirety.

What is claimed is:

1. A measurement apparatus which measures a surface position of an object, the apparatus comprising:
a first measurement device configured to make measurement light from the object and reference light from a reference mirror interfere with each other on a light receiving surface of a photo-electric conversion device to form an interference pattern, and photo-electrically convert the interference pattern by the photo-electric conversion device to output an interference signal;
a second measurement device configured to measure the surface position of the object; and
an arithmetic processing unit configured to detect the surface position of the object based on a peak, of the interference signal, which is ensured to be a peak of a central fringe according to the measurement result obtained using said second measurement device.

2. The apparatus according to claim 1, wherein said arithmetic processing unit determines a range including the central fringe based on the measurement result obtained using said second measurement device, and detects the surface position of the object by determining a peak of the interference signal in the range as the peak of the central fringe.

3. The apparatus according to claim 1, wherein said arithmetic processing unit determines a range including the central fringe based on the measurement result obtained by said measurement device, acquires the interference signal in the range by said first measurement device, and detects the surface position of the object by determining only one peak included in the interference signal as the peak of the central fringe.

4. The apparatus according to claim 1, wherein said second measurement device includes a measurement device configured to obliquely irradiate the object with light, and measure the surface position of the object based on an image forming position of the light reflected by the object.

5. An exposure apparatus which projects a pattern of an original onto a substrate by a projection optical system to expose the substrate, the apparatus comprising:
a first measurement device configured to make measurement light from the substrate and reference light from a reference mirror interfere with each other on a light receiving surface of a photo-electric conversion device to form an interference pattern, and photo-electrically convert the interference pattern by the photo-electric conversion device to output an interference signal;
a second measurement device configured to measure a surface position of the substrate using a grazing-incidence scheme; and
an arithmetic processing unit configured to detect the surface position of the substrate based on a peak, of the interference signal, which is ensured to be a peak of a central fringe according to the measurement result obtained using said second measurement device.

6. A device manufacturing method comprising the steps of:
exposing a substrate using an exposure apparatus configured to project a pattern of an original onto the substrate by a projection optical system; and
developing the substrate,
wherein the exposure apparatus comprises:
a first measurement device configured to make measurement light from the substrate and reference light from a reference mirror interfere with each other on a light receiving surface of a photo-electric conversion device to form an interference pattern, and photo-electrically convert the interference pattern by the photo-electric conversion device to output an interference signal;
a second measurement device configured to measure a surface position of the substrate using a grazing-incidence scheme; and
an arithmetic processing unit configured to detect the surface position of the substrate based on a peak, of the interference signal, which is ensured to be a peak of a central fringe according to the measurement result obtained using said second measurement device.
